(19) United States
(12) Patent Application Publication
(10) Pub. No.: US 2025/0287207 A1
(43) Pub. Date: Sep. 11, 2025

(54) ENHANCED WIRELESS DEVICE MANAGEMENT PERMISSIONS

(71) Applicant: T-Mobile Innovations LLC, Overland Park, KS (US)

(72) Inventor: Paul AVETOOM, Renton, WA (US)

(21) Appl. No.: 18/601,113

(22) Filed: Mar. 11, 2024

(51) Int. Cl. H04W 12/08; H04W 12/069

(52) U.S. Cl. CPC H04W 12/08; H04W 12/069

(57) ABSTRACT

Systems, methods and non-transitory computer-readable mediums are provided for a wireless device management (WDM) system and method granting permission for a limited duration to make changes/updates to firmware and/or configuration profile of a wireless device. A time-based certificate is transmitted from the WDM to the wireless device. Upon expiration of the time-based certificate, the WDM may no longer make changes/updates to the wireless device.

### TECHNICAL BACKGROUND

Most smart phones such as iPhone®, Samsung Galaxy®, Google Pixel® etc. are configured when mobile service is initiated by a mobile network operator (MNO). Additional configuration changes may also be made to smart phones.

Upon configuration, the wireless devices communicate with a base station or access node. Access nodes may deploy different carriers within the cellular network utilizing different types of radio access technologies (RATs). RATs can include, for example, 3G RATs (e.g., GSM, CDMA etc.), 4G RATs (e.g., WiMax, LTE, etc.), and 5G RATs (new radio (NR)) and 6G RATs. Further, different types of access nodes may be implemented for deployment for the various RATs. For example, an evolved NodeB (eNodeB or eNB) may be utilized for 4G RATs and a next generation NodeB (gNodeB or gNB) may be utilized for 5G RAT.

### OVERVIEW

Exemplary embodiments described herein include systems, methods, and processing nodes for making changes/updates to firmware and/or configuration profile of a wireless device. A time-based certificate is transmitted from wireless device management (WDM) system granting permission to the WDM system to make changes to firmware and/or configuration profile of a wireless device. The changes to the firmware and/or configuration profile are transmitted to the wireless device. Upon expiration of the time-based certificate, the granted to the WDM system to make changes to the wireless device ends and the WDM system can no longer make changes to the wireless device.

The WDM system may receive a request to make changes to firmware and/or configuration profile of the wireless device. The request to make changes may originate from the wireless device or wireless device manufacturer of the wireless device. The changes to the firmware and/or configuration profile of a wireless device may comprise changes to the configuration profile of the wireless device. In some examples, the changes to firmware and/or configuration profile are transmitted by firmware over-the-air (FOTA). In some examples, a timer is associated with the time-based certificate and the timer is started upon the transmission of changes to the firmware and/or configuration profile to the wireless device.

In another example, a system comprises a memory storing instructions, a processor for accessing the memory and executing the instructions to perform operations. The instructions comprise transmitting a time-based certificate from an WDM system granting permission for the WDM system to make changes to a configuration profile of a wireless device. The instructions further comprise transmitting the changes to the configuration profile of the wireless device. Upon expiration of the time-based certificate, the permission granted to the WDM system to make changes to the wireless device ends.

A method is provided for receiving a time-based certificate at a wireless device from an WDM system granting permission the WDM system to make changes to the wireless device. The method further provides receiving the changes to the configuration profile of the wireless device and executing the changes to the configuration profile of the wireless device until expiration of the time-based certificate. The wireless device may prevent the WDM system from making changes to the wireless device after the expiration of the time-based certificate.

The time-based certificate may include a timer. The timer may be associated with an internal clock of the wireless device. The changes to the configuration profile of the wireless device may be changes to the configuration profile of the device. The changes to the configuration profile of the wireless device may be made to a subscriber identity module (SIM) of the wireless device.

### BRIEF DESCRIPTION OF THE DRAWINGS

FIG. 1 depicts an exemplary operating environment for an WDM system in accordance with the disclosed embodiments.

FIG. 2 illustrates an WDM system in accordance with disclosed embodiments.

FIG. 3 illustrates an exemplary transmission and revocation of a time-based certificate from an WDM system in accordance with disclosed embodiments.

FIG. 4 depicts an exemplary method for revoking permission to make changes to a wireless device in accordance with disclosed embodiments.

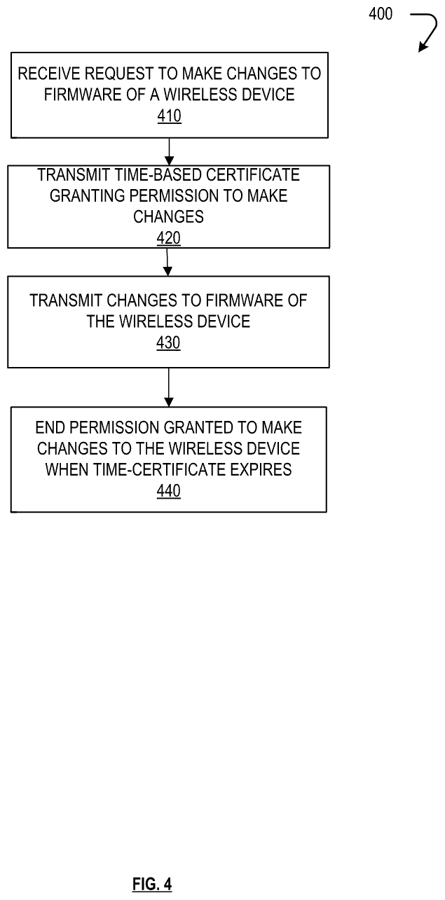

FIG. 5 depicts changing firmware and/or configuration profile of a wireless device in accordance with disclosed embodiments.

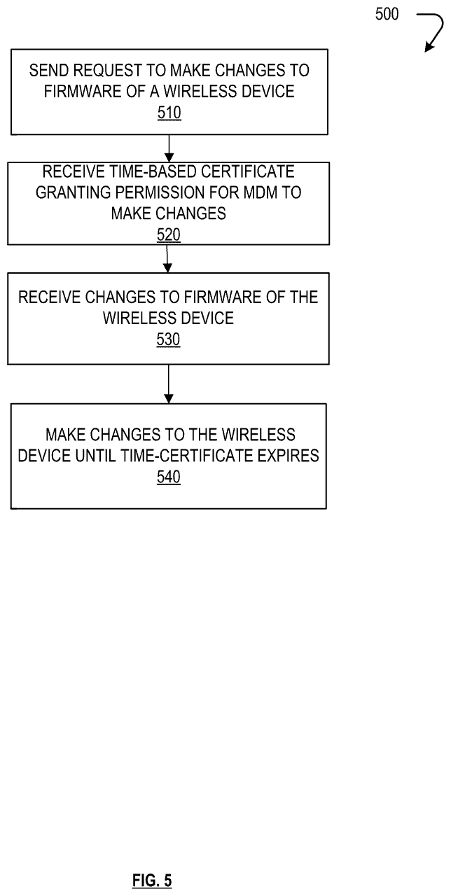

### DETAILED DESCRIPTION

Firmware Over-The-Air (FOTA) is a Mobile Software Management (MSM) technology in which the operating firmware of a wireless device is wirelessly upgraded and updated. FOTA-capable wireless devices are capable of downloading upgrades directly. The process usually takes a few minutes, depending on connection speed and file size. FOTA facilitates repairing bugs in new units, and installing new updates, features and services—even after a device has been purchased.

Software and firmware are stored differently. Software is generally stored on a hard drive, while firmware is stored on a read-only memory chip or flash memory chip, such as a SIM card. Firmware controls access to the hardware. Firmware can also be a bridge between the software and the hardware. For example, the firmware on a smartphone helps ensure that the operating system starts up when the power button is pressed.

When changes to firmware and/or configuration profile are needed, the entity updating the device typically takes full control of a wireless device which allows access to all content and is thus is subject to privacy issues. The WDM system described herein alleviates privacy issues. The WDM system requests explicit approval to access the device and access is limited to a specific purpose and

machine-to-machine transactions and excludes access to personal information.

In addition, the WDM system limits the duration of access to the wireless device. The WDM system provides a time-based certificate (e.g., 5 minutes from transmission of changes to firmware and/or configuration profile) which expires based on the internal clock of the wireless device. The time-based certificate may also be revoked manually by the wireless device user or by the WDM system before the time-based certificate expires.

Previously, a wireless device subscriber received a SIM card from an MNO and inserted it into the wireless device. The MNO activated the subscriber's line of service and provided guidance on how to manually update settings on the wireless device to allow network services to work. The subscriber manually updated APN (Data and Tethering) and MMSC settings manually to allow features on the wireless device to work.

Using the WDM system described herein, in one example, a wireless device subscriber receives a SIM card from an MNO and inserts it into the wireless device. The MNO activates the subscriber's line of service. The WDM system triggers an SMS to the wireless device asking for permission to access device for a variable duration to allow firmware and/or a configuration profile of the device to be updated/changed. In one example, the SMS is sent to the wireless device via Wi-Fi.

A time-based certificate is approved by subscriber providing the WDM system access to the wireless device to make changes to the firmware and/or configuration profile of the wireless device. The WDM system determines the relevant device firmware and/or configuration profile to be transmitted and loaded to the wireless device, without subscriber intervention. The WDM system transmits the firmware (configuration profile) to the subscriber device. Once configuration settings and/or firmware are sent and completed, message is sent to the wireless device indicating completion of process and access using the time-based certificate is revoked.

If configuration is not complete within the variable duration defined by the time-based certificate, the time-based certificate is automatically revoked. A notification is sent to the subscriber device of the expiration and an option is provided to receive another time-based certificate to complete the changes/update to firmware and/or configuration profile.

In another example, a subscriber contacts a mobile phone manufacture indicating they are having an issue with their line of service. Previously, subscribers manually verified FOTA capability via wireless device settings and accessed FOTA updates via the device menu under phone/device management or software/firmware update.

In described herein, the device manufacturer requests that the MNO validate the device and network settings. The MNO identifies the device. In one instance, the MNO queries its core network and identifies the wireless device as an Apple (iOS). The MNO sends a request to the subscriber on behalf of the manufacturer for access to the subscriber device and to provide automated customer support using a time-based certificate without subscriber manually updating the firmware and/or configuration profile.

The WDM system triggers an SMS to the wireless device asking for permission to access device for a variable duration to allow firmware and/or configuration settings of the device to be updated/changed. A time-based certificate is approved by subscriber providing the WDM system access to the wireless device to make changes to the firmware and/or configuration settings of the wireless device using automated customer support. In one examples, FOTA is used to make changes/update to the firmware and/or configuration settings of the wireless device.

The WDM system determines the subscriber device configuration and network information are checked to identify if an issue exists against manufacturer's configuration, without subscriber intervention. If configuration issue is found, a firmware and/or configuration profile update is transmitted to the wireless device to correct issue using machine to machine communication and a pre-configured set of instructions/code. The subscriber is informed that issue has been found and resolved.

The WDM system transmits the firmware and/or configuration settings update to the subscriber device. Once firmware and/or configuration settings update is sent and completed, message is sent to the wireless device indicating completion of process and access using the time-based certificate is revoked. If configuration is not complete within the variable duration defined by the time-based certificate, the time-based certificate is automatically revoked. A notification is sent to the subscriber device of the expiration and an option is provided to receive another time-based certificate to complete the changes/update to firmware and/or configuration profile.

Additionally, the MNO creates a trouble ticket for the transaction and discrepancy details regarding the issue are loaded into the ticket.

In addition to the systems and methods described herein, the operations for granting time-based permission to update firmware and/or configuration profile of a wireless device may be implemented as computer-readable instructions or methods, and processing nodes on the network for executing the instructions or methods. The processing node may include a processor included in the access node or a processor included in any controller node in the wireless network that is coupled to the access node.

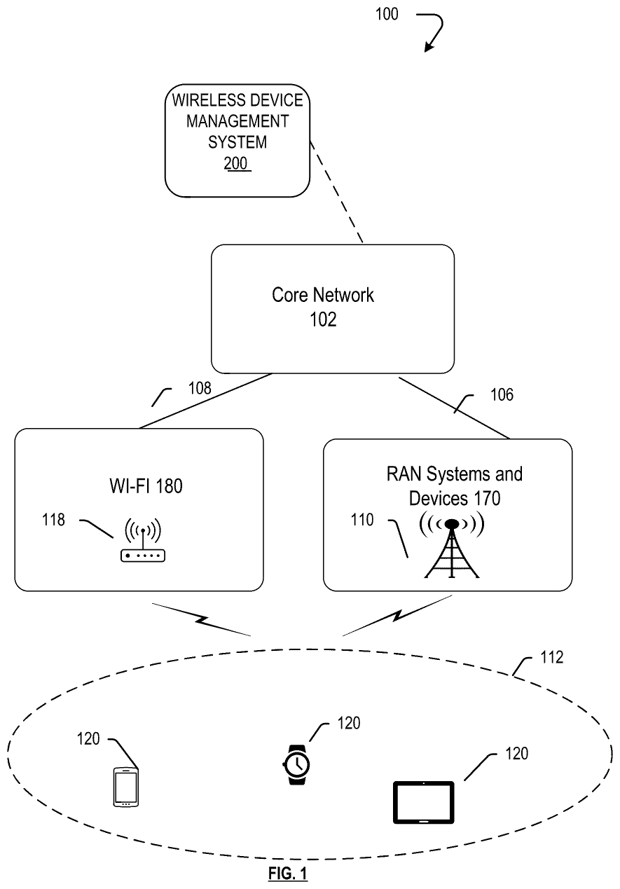

FIG. 1 depicts an exemplary environment 100 for an WDM system 200 in accordance with the disclosed embodiments. The environment 100 may include a core network 102 and a radio access network (RAN) 170, including at least one access node 110. The RAN 170 may include other devices and additional access nodes.

The environment 100 also includes multiple wireless devices 120 which may be end-user wireless devices such as smart phones and may operate within one or more coverage areas 112, 122. The wireless devices 120 in the coverage area 112 communicate with the RAN 170 over communication link 106, which may for example be a 5G NR and/or 4G LTE communication link. Wireless devices 120 communicate with WI-FI 180 over communication link 108.

The environment 100 may further include an WDM system 200, which is illustrated as operating at the core network 102. However, it should be noted that the WDM system 200 may be distributed. Alternatively, the WDM system 200 may be an entirely discrete component, such as a processing node.

The WDM system 200 receives information from wireless devices 120 for implemented time-based firmware and/or configuration profile updates. Based on data received from the wireless devices 120. the WDM system 200 transmitting a time-based certificate from the WDM system granting permission the WDM system to make changes to firmware and/or configuration profile of a wireless device. Changes to the firmware and/or configuration profile to the wireless device are transmitted to the wireless device. After expiration of the time-based certificate, the permission granted to the WDM system to make changes to the wireless device is revoked.

The core network 102 includes core network functions and elements. The core network 102 may have an evolved packet core (EPC) or may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120 and is responsible for handling connection and mobility management tasks. The SMF is primarily responsible for creating, updating, and removing sessions and managing session context. The UDM function provides services to other core functions, such as the AMF, SMF, and NEF. The UDM may function as a stateful message store, holding information in local memory. The NSSF can be used by the AMF to assist with the selection of network slice instances that will serve a particular device. Further, the NEF provides a mechanism for securely exposing services and features of the core network. The core network 102 may further include one or more databases.

Communication link 106 can use various communication media, such as air, space, metal, optical fiber, or some other signal propagation path, including combinations thereof. Communication link 106 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Other wireless protocols can also be used. Communication links 106 and 108 can be direct links or might include various equipment, intermediate components, systems, and networks, such as a cell site router, etc. Communication links 106 and 108 may comprise many different signals sharing the same link.

The RAN 170 may include various access network systems and devices such as access node 110. The RAN 170 is disposed between the core network 102 and the end-user wireless devices 120. Components of the RAN 170 may communicate directly with the core network 102 and others may communicate directly with the end user wireless devices 120. The RAN 170 may provide services from the core networks 102 to the end-user wireless devices 120.

The RAN 170 includes at least an access node (or base station) 110 such as an eNodeB of gNodeB 110 communicating with the plurality of end-user wireless devices 120. It is understood that the disclosed technology may also be applied to communication between an end-user wireless device and other network resources, such as relay nodes, controller nodes, antennas, etc. Further, multiple access nodes may be utilized. For example, some wireless devices may communicate with an LTE eNodeB, and others may communicate with an NR gNodeB.

Access node 110 can be, for example, standard access nodes such as a macro-cell access node, a base transceiver station, a radio base station, an eNodeB device, an enhanced eNodeB device, a gNodeB in 5G New Radio (“5G NR”), or the like. The gNBs may include, for example, centralized units (CUs) and distributed units (DUs). Access node 110 can be configured to deploy one or more different carriers, utilizing one or more RATs. For example, a gNodeB may support NR and an eNodeB may provide LTE coverage. Any other combination of access nodes and carriers deployed therefrom may be evident to those having ordinary skill in the art in light of this disclosure.

The access nodes 110 can comprise a processor and associated circuitry to execute or direct the execution of computer-readable instructions to perform operations such as those further described herein. Access nodes 110 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless gateway device 118 may be or include a router or router/modem combination that deploys a wireless local area network (WLAN) 150 providing Internet access via Wi-Fi 180 to wireless devices 120.

The wireless devices 120 may include any wireless device included in a wireless network. Wireless devices 120 may be any device, system, combination of devices, or other such communication platform capable of communicating wirelessly with access network 110 using one or more frequency bands and wireless carriers deployed therefrom and further capable of communicating with the network 101. Each of wireless devices 120, may be, for example, a mobile phone, a wireless phone, a wireless modem, a smart watch, a tablet, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless devices 120 may be or include high power wireless devices or standard power wireless devices. Other types of communication platforms are possible.

Environment 100 may further include many components not specifically shown in FIG. 1 including processing nodes, controller nodes, routers, gateways, and physical and/or wireless data links for communicating signals among various network elements. Environment 100 may include one or more of a local area network, a wide area network, and an internetwork (including the Internet). Environment 100 may be capable of communicating signals and carrying data, for example, to support voice, push-to-talk, broadcast video, and data communications by end-user wireless devices 120. Environment 100 may include additional base stations, controller nodes, telephony switches, internet routers, network gateways, computer systems, communication links, or other type of communication equipment, and combinations thereof.

Other network elements may be present in the environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the access networks 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes, including access nodes, controller nodes, and gateway nodes described herein.

The operations for transmitting time-based updates to firmware and/or configuration profile on wireless devices may be implemented as computer-readable instructions or methods, and processing nodes on the network for executing the instructions or methods. The processing node may include a processor included in the access node or a processor included in any controller node in the wireless network that is coupled to the access node.

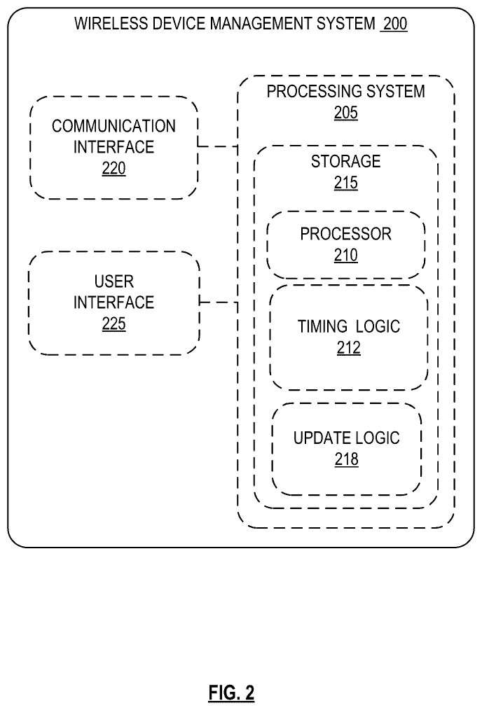

FIG. 2 depicts further details of the WDM system 200, which may be configured to perform the methods and operations disclosed herein to update firmware and/or configuration profile of a wireless device. In the disclosed embodiments, the WDM system 200 may be integrated with the core network 102, or may be an entirely separate component, such as a processing node, capable of communicating with the wireless devices 120.

The WDM system 200 may be configured to receive requests from wireless devices 120 to update firmware and/or configuration profile. The requests from the wireless devices 120 may include information about the type of device, device configuration, and network information. The WDM system 200 may transmit a time-based certificate to allow the WDM system 200 to make updates to firmware and/or configuration profile of a wireless device.

The WDM system 200 includes a processing system 205. Processing system 205 may include a processor 210 and a storage device or memory 215. Storage device 215 may include a disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware and/or configuration profile, or other form of machine-readable instructions, including an operating system, utilities, drivers, network interfaces, applications, or other type of software. For example, software stored in storage device 215 may include one or more modules for performing various operations described herein. For example, time logic 212 may be provided to include instructions to limit the duration the WDM system can make changes/updates to a wireless device. Further, firmware update logic 218 may include instructions for transmitting changes/updates to firmware and/or configuration profile from the WDM system to a wireless device. Processor 210 may be a microprocessor and may include hardware circuitry and/or embedded codes configured to retrieve and execute software stored in storage device 215.

Communication interface 220 may include hardware components, such as network communication ports, circuitry, devices, routers, wires, antenna, transceivers, etc. These components may, for example, receive requests from the wireless devices 120 User interface 225 may be configured to allow a user to provide input to the WDM system 200 and receive data or information from the WDM system 200. User interface 225 may include hardware components, such as touch screens, buttons, displays, speakers, etc. The WDM system 200 may further include other components such as a power management unit, a control interface unit, etc.

The WDM system 200 thus may utilize the memory 215 and the processor 210 to perform multiple operations. For example, the processor 210 may access stored instructions in the memory 215. The location of the WDM system 200 may depend upon the network architecture. For example, in smaller networks, a single WDM system 200 may be disposed for communication with wireless devices 120. However, in a larger network, multiple WDM systems 200 may be required to cover the network.

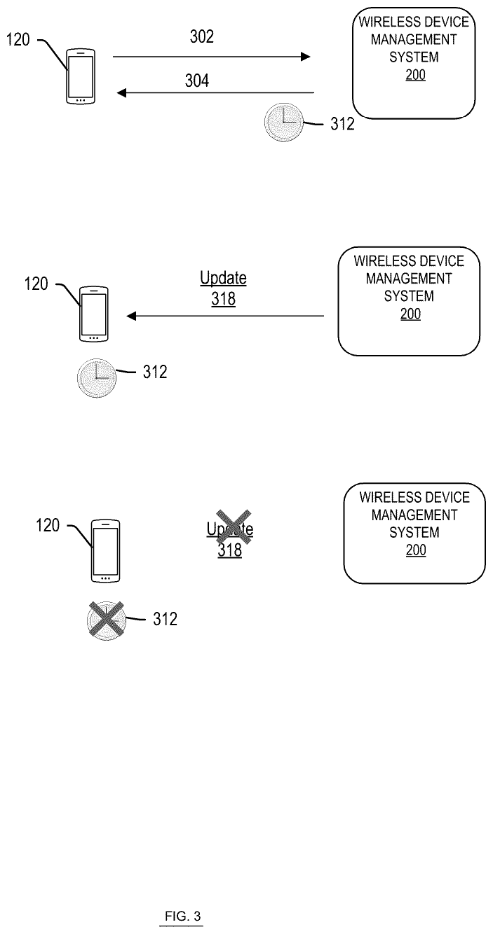

FIG. 3A illustrates an exemplary configuration for granting permissions to update firmware and/or configuration profile method in accordance with disclosed embodiments. As shown in FIG. 3A, the wireless device 120 sends a request 302 to an WDM system 200. The request 302 may include information about the type of device, device configuration, network information, and firmware and/or configuration profile of wireless device 120. Based on the request 302, the WDM system 200 transmits 304 a time-based certificate 312 granting permission the WDM system 200 to make changes 318 to firmware and/or configuration profile of the wireless device 120. For example, the time-based certificate 312 may be of limited time duration granting permission for the WDM system 200 to make changes to firmware and/or configuration profile during the limited time duration.

Thus, in response to the request 302, the WDM system 200 may set a timer for time-based certificate 312 and grant temporary access or permission for WDM system 200 to make changes/updates 318 to firmware and/or configuration profile of wireless device 120. The changes/updates to firmware and/or configuration profile include changes/update to the configuration profile of the wireless device. The configuration profile comprises specific payloads that may be specified, including (but not limited to), passcode and password policies, restrictions on device features (for example, disabling the camera), network settings, virtual private network (VPN) settings, mail settings, account settings, lightweight directory access protocol (LDAP) directory service settings, calendar service settings, and credentials and keys.

Time-based certificate 312 may be incorporated in the timing logic 212 described above with reference to FIG. 2 or in another location within the WDM system 200. Upon expiration of the time-based certificate 312, permission to make changes/updates 318 to firmware and/or configuration profile of the wireless device 120 expires and the WDM system 200.

Method 400 begins in step 410, when the WDM system 200 receives a request to make changes to firmware and/or configuration profile of a wireless device. Specifically, the request may be from the wireless device or wireless device manufacturer. The changes may be to a configuration profile of the wireless device. The configuration profile comprises specific payloads that may be specified, including (but not limited to), passcode and password policies, restrictions on device features (for example, disabling the camera), network settings, virtual private network (VPN) settings, mail settings, account settings, lightweight directory access protocol (LDAP) directory service settings, calendar service settings, and credentials and keys.

Upon receiving the request, the WDM system 200 transmits a time-based certificate granting permission for the WDM to make changes to the wireless device in step 420. In some examples, the WDM first sends a message, such as an SMS, to the wireless device requesting permission to make changes.

Specifically, the WDM system 200 transmits the time-based certificate to the wireless device. The time-based certificate has an associated timer sch that the WDM 200 is only able to make changes to the wireless device for a limited period of time, for example, for a few minutes or how long the changes/updates are expected to take.

In step 430, the WDM 200 transmits the changes/updates to firmware and/or configuration profile to the wireless device so that the wireless device may implement the changes/updates. In one example, the changes/updates may be communicated using FOTA from the WDM 200 to the wireless device to be updated.

Finally, in step 440, the permission for the WDM to make changes to the wireless device ends when the time-certificate expired. The WDM system will no longer be able to make changes to the wireless device after expiration of the time-certificate. If changes/updates to firmware and/or configuration profile are not complete within the variable duration defined by the time-based certificate, the time-based certificate is automatically revoked. A notification is sent to the subscriber device of the expiration and an option is provided to receive another time-based certificate to complete the changes/update to firmware and/or configuration profile.

The time-based certificate method provides a safe and limited method for changes/updates to be made to a wireless device. In some examples, the changes/updates are made using FOTA. The limited duration of the time-based certificate allows the WDM to take control of the device for a limited duration and/or purpose. Further, in some examples, the subscriber of the device grants explicit approval (e.g., through SMS text conformation) for the WDM to access the device with knowledge that the access is limited to a specific purpose,

excludes access to personal information and/or is for a limited duration.

In some examples, the wireless device subscriber may choose to end the permission early and may choose to do so. In some examples, upon successful changes/updates to the firmware and/or configuration profile of a wireless device, the WDM system may end the permission earlier.

Method 500 begins in step 510, when the wireless device sends a request for updates/changes to firmware and/or configuration profile of the wireless device. The request may be made at the time of setting up a new device or when using the device and encountering a configuration issue. The WDM system 200 receives the request from the wireless device.

Upon receiving the request, at step 520, the wireless device receives a time-based certificate granting permission for the WDM system 200 to make updates/changes to firmware and/or configuration profile of the wireless device. In some examples, a time duration is associated with the time-based certificate and an internal clock of the wireless device is set with a timer for the specified duration.

At step 530, the wireless device receives the updates/changes to firmware and/or configuration profile of the wireless device from the WDM system. The updates/changes to the firmware and/or configuration profile of the wireless device may include changes to the configuration profile of the wireless device. The wireless device makes the updates/changes to the firmware and/or configuration profile of the wireless device until expiration of the time-based certificate.

At step 540, upon expiration of the time-based certificate the wireless device stops making changes/updates to the firmware and/or configuration profile of the device. If the updates/changes to firmware and/or configuration profile are not complete within the variable duration defined by the time-based certificate, the time-based certificate is automatically revoked. A notification may be sent to the subscriber wireless device of the expiration and an option is provided to receive another time-based certificate to complete the changes/update to firmware and/or configuration profile.

In some embodiments, methods 400 and 500 may include additional steps or operations. Furthermore, the methods may include steps shown in each of the other methods. As one of ordinary skill in the art would understand, the methods 400 and 500 may be integrated in any useful manner and the steps may be performed in any useful sequence.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
transmitting a time-based certificate from a wireless device management (WDM) system granting permission the WDM system to make changes to a configuration profile of a wireless device;
transmitting changes to the configuration profile to the wireless device; and
upon expiration of the time-based certificate, ending the permission granted to the WDM to make changes to the wireless device.

2. The method of claim 1, wherein the changes to the configuration profile are transmitted by firmware over-the-air (FOTA).

3. The method of claim 1, further comprising:
receiving a request to make changes to the configuration profile of the wireless device.

4. The method of claim 3, wherein the request to make changes originates from the wireless device or wireless device manufacturer of the wireless device.

5. The method of claim 1, wherein a timer is associated with the time-based certificate.

6. The method of claim 5, wherein the timer is started upon the transmitting the changes to the configuration profile to the wireless device.

7. The method of claim 1, wherein the changes to the configuration profile of a wireless device comprise changes to firmware of the wireless device.

8. A system comprising:
a memory storing instructions; and
a processor accessing the memory and executing the instructions to perform operations including:
transmitting a time-based certificate from a wireless device management (WDM) system granting permission the WDM system to make changes to a configuration profile of a wireless device;
transmitting the changes to the configuration profile of the wireless device; and
upon expiration of the time-based certificate, ending the permission granted to the WDM system to make changes to the wireless device.

9. The system of claim 8, wherein the changes to the firmware of a wireless device comprise changes to firmware of the wireless device.

10. The system of claim 8, wherein the WDM system can no longer make changes to the wireless device.

11. The system of claim 9, wherein the changes to firmware are transmitted by firmware over-the-air (FOTA).

12. The system of claim 1, further comprising:
receiving a request to make changes to the configuration profile of the wireless device.

13. The system of claim 12, wherein the request to make changes originates from the wireless device or wireless device manufacturer of the wireless device.

14. A method comprising:
receiving a time-based certificate from a wireless device management (WDM) system granting permission the WDM system to make changes to a wireless device;
receiving the changes to a configuration profile of the wireless device; and
executing the changes to the configuration profile of the wireless device until expiration of the time-based certificate.

15. The method of claim 14, further comprising:
sending a request from the wireless device for changes to be made to the configuration profile of the wireless device.

16. The method of claim 15, further comprising:
preventing the WDM system from making changes to the wireless device after expiration of the time-based certificate.

17. The method of claim 14, wherein a timer is associated with the time-based certificate.

18. The method of claim 17, further comprising:
associating the timer with an internal clock of the wireless device.

19. The method of claim 14, wherein the changes to the configuration profile of the wireless device are firmware to the configuration profile of the wireless device.

20. The method of claim 19, wherein the changes to the firmware of the wireless device are made to a subscriber identity module (SIM) of the wireless device.
